(19) United States
(12) Patent Application Publication
(10) Pub. No.: US 2002/0157645 A1
(43) Pub. Date: Oct. 31, 2002

(54) Common rail injector

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/914,381

(22) PCT Filed: Dec. 1, 2000
(86) PCT No.: PCT/DE00/04280

(30) Foreign Application Priority Data
Dec. 28, 1999 (DE) 199 63 367.3

(51) Int. Cl. F02M 1/00

(52) U.S. Cl. 123/456; 123/470

(57) ABSTRACT

The invention relates to a common rail injector for injecting fuel in a common rail injection system of an internal combustion engine, which has an injector housing (1) with a fuel inlet (24) that communicates with a central high-pressure fuel reservoir outside the injector housing (1), and which can be made to communicate with a high-pressure conduit (25) inside the injector housing (1), from which conduit fuel subjected to high pressure is injected into the combustion chamber of the engine when a control valve member (8), movable axially back and forth in a longitudinal bore (4) of the injector (1) lifts, with a first valve sealing face (9), from a first valve seat (10) as a function of the pressure in a control chamber (29).

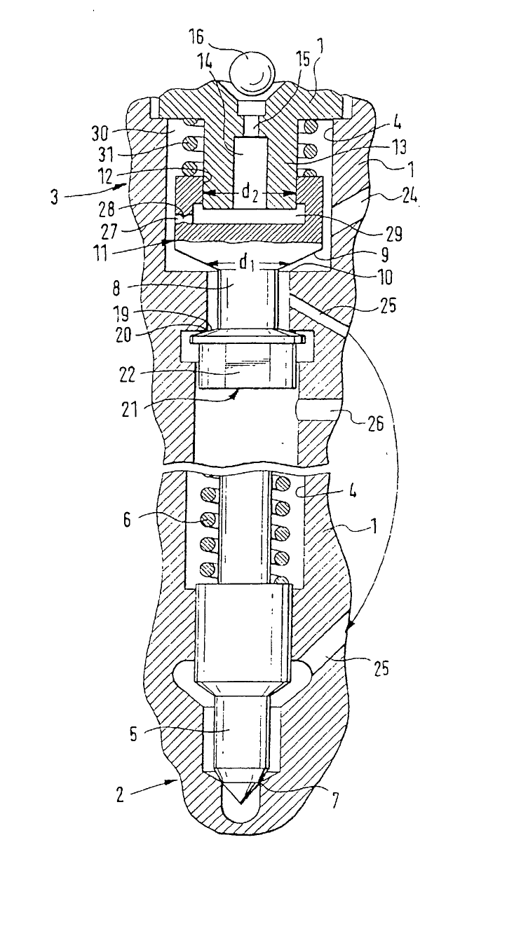

In order to furnish a rapid respond common rail injector that at least partly functions in force equilibrium, the control chamber (29) is formed by a substantially cylindrical recess (12), provided in the end (11) of the control valve member (8) remote from the combustion chamber, the diameter (d₂) of which recess is greater than the diameter (d₁) of the first valve seat (10), and which recess at least partly surrounds a guide peg (13) that is stationary relative to the injector housing (1).

### PRIOR ART

The invention relates to a common rail injector for injecting fuel in a common rail injection system of an internal combustion engine, which has an injector housing with a fuel inlet that communicates with a central high-pressure fuel reservoir outside the injector housing, and which can be made to communicate with a high-pressure conduit inside the injector housing, from which conduit fuel subjected to high pressure is injected into the combustion chamber of the engine when a control valve member, movable axially back and forth in a longitudinal bore of the injector lifts, with a first valve sealing face, from a first valve seat as a function of the pressure in a control chamber.

In common rail injection systems, a high-pressure pump pumps the fuel into the central high-pressure reservoir, which is called a common rail. From the rail, high-pressure lines lead to the individual injectors that are assigned to the engine cylinders. The injectors are triggered individually by the engine electronics. The rail pressure in the fuel inlet prevails at the control valve member. When the control valve member opens, fuel subjected to high pressure flows from the fuel inlet into the high-pressure conduit.

One conventional injector is describe in German Patent Disclosure DE 197 01 879. In this known injector, the control valve member is embodied as a stepped piston, whose cross section tapers toward the combustion chamber by way of two conically embodied annular faces. The differences in diameter are dictated by assembly and production considerations. In particular, because of the diameter differences, it becomes possible to grind out the first valve seat face on the control valve member. The diameter differences create a pressure shoulder which cannot be force-balanced, even in part.

The object of the invention is to furnish a rapidly responding common rail injector of the type defined at the outset that is simple in design and can be produced economically. In particular, the control valve member should function at least partly in force equilibrium.

In a common rail injector for injecting fuel in a common rail injection system of an internal combustion engine, which has an injector housing with a fuel inlet that communicates with a central high-pressure fuel reservoir outside the injector housing, and which can be made to communicate with a high-pressure conduit inside the injector housing, from which conduit fuel subjected to high pressure is injected into the combustion chamber of the engine when a control valve member, movable axially back and forth in a longitudinal bore of the injector lifts, with a first valve sealing face, from a first valve seat as a function of the pressure in a control chamber, this object is attained in that the control chamber is formed by a substantially cylindrical recess, provided in the end of the control valve member remote from the combustion chamber, the diameter of which recess is greater than the diameter of the first valve seat, and which recess at least partly surrounds a guide peg that is stationary relative to the injector housing.

### ADVANTAGES OF THE INVENTION

The inside diameter of the recess that forms an internal guide can be selected essentially freely, regardless of the valve seat diameter, since the outside diameter of the control valve member in the region of the recess can be virtually arbitrarily large in size and is limited only by the dimensions of the injector housing. Because of the larger inside diameter, overcompensation for the sake of sealing is achieved. The force equilibrium is freely selectable The first valve seat face can be ground independently of the guide diameter.

One particular type of embodiment of the invention is characterized in that a first relief conduit is embodied in the guide peg and connects the control chamber to a relief chamber when a blocking device opens. The blocking device can for instance be a valve ball that is pivotably connected to the armature of a magnet valve.

A further particular type of embodiment of the invention is characterized in that in the end, toward the control chamber, of the control valve member an inlet bore with an inlet throttle is provided, which discharges into the recess, and whose cross section is smaller than the cross section of the first relief conduit. As a result, adequate filling of the control chamber from the fuel inlet in operation of the injector of the invention is assured.

A further particular type of embodiment of the invention is characterized in that a prestressed control valve spring is disposed outside the guide peg, between the control valve member and the valve housing. The control valve spring makes a fast interruption of the communication between the fuel inlet and the high-pressure conduit possible. Furthermore, the prestressing force of the control valve spring leads to an additional sealing action upon shutoff of the engine.

A further particular type of embodiment of the invention is characterized in that the control valve member has a second valve sealing face, which cooperates with a second valve seat in order to open and close a communication between the high-pressure conduit and a second relief conduit that communicates with the relief chamber. As a result, a rapid pressure buildup in the high-pressure conduit after the injection is assured. The end of the control valve member remote from the combustion chamber can also be embodied as a slide valve, as described in DE 197 01 879.

Further advantages, characteristics and details of the invention will become apparent from the ensuing description, in which one exemplary embodiment of the invention is described in detail in conjunction with the drawing. The characteristics recited in the claims and mentioned in the description can each be essential to the invention individually or in arbitrary combination with one another.

### DRAWING

The accompanying figure shows an exemplary embodiment of an injector of the invention in longitudinal section.

### DESCRIPTION OF THE EXEMPLARY EMBODIMENT

The common rail injector shown in longitudinal section in the accompanying drawing includes an injector housing 1, which is embodied in multiple parts. The injector housing 1 has one end 2 toward the combustion chamber, from which end the injection into the combustion chamber of the internal combustion engine to be supplied takes place, and one end 3 remote from the combustion chamber. A bore 4 is embodied in the end 3 of the injector housing 1 remote from the combustion chamber and extends as far as the end 2 of the injector housing 1 toward the combustion chamber. A nozzle needle 5 is received axially displaceably, counter to the prestressing force of a nozzle needle spring 6, in the end 2 of the injector housing 1 toward the combustion chamber. The nozzle needle 5 is located with its tip in contact with a nozzle needle seat 7. When the nozzle needle 5 lifts from the nozzle needle seat 7, fuel subjected to high pressure is injected through injection openings (not shown) into the combustion chamber of the engine.

A control valve member 8 that is independent of the nozzle needle 5 is received, capable of motion back and forth, in the end 3 of the injector housing 1 remote from the combustion chamber. The control valve member 8 has the form of a circular cylinder, which widens in conical fashion on its end 11 remote from the combustion chamber, in order to form a first valve sealing face 9. The first valve sealing face 9 of the control valve member 8 cooperates with a first valve seat 10, which is embodied in the injector housing. The first valve seat 10 has a seat diameter d₁.

Adjoining the first valve sealing face 9, on the end 11 of the control valve member 8 remote from the combustion chamber, a circular-cylindrical portion with a widened outside diameter is formed. In the end 11 of the control valve member 8 remote from the combustion chamber, a recess 12 is provided, in the form of a bore having a diameter d₂. A guide peg 13, which originates at one part of the injector housing 1, is received in the recess 12. The control valve member 8 is guided axially displaceably by the guide peg 13. A relief conduit 14 with an outlet throttle 15 is disposed centrally in the guide peg 13. The relief conduit 14 connects the recess 12, in the end 11 of the control valve member 8 remote from the combustion chamber, to a relief chamber (not shown). The relief conduit 14 can be closed by a valve ball 16, which is part of a magnet valve (not shown).

A second valve sealing face 19 is embodied on the end 21 of the control valve member 8 toward the combustion chamber and cooperates with a second valve seat 20, which is embodied in the injector housing 1. Adjoining the second valve sealing face 19, a substantially cylindrical end portion is formed on the control valve member 8 and assures that fuel will flow past a flat face 22. The end 21 of the control valve member 8 toward the combustion chamber can be embodied in the same way as in the injector known from DE 197 01 879.

The first valve seat 10 is disposed in the injector housing 1 between the orifice of a fuel inlet 24 and a high-pressure conduit 25. When the first valve sealing face 9 of the control valve member 8 is in contact with the first valve seat 10, the communication between the fuel inlet 24 and the high-pressure conduit 25 is thus interrupted.

The second valve seat 20 is disposed in the injector housing 1 between the high-pressure conduit 25 and a second relief conduit 26. When the second valve sealing face 19 of the control valve member 8 is in contact with the second valve seat 20, the communication between the high-pressure conduit 25 and the second relief conduit 26 is thus interrupted.

The fuel inlet 24 communicates with a control chamber 29 in the interior of the recess 12, via an inlet bore 27, provided in the end 11 of the control valve member 8 remote from the combustion chamber, in which bore an inlet throttle 28 is embodied. Outside the control chamber 29, a control valve spring chamber 30 is embodied inside the bore 4 in the injector housing 1. A control valve spring 31 is installed with prestressing in the control valve spring chamber 30, between the end 11 of the control valve member 8 remote from the combustion chamber and the injector housing 1.

In the position of the control valve shown in the drawing, the valve ball 16 has lifted from its associated seat, so that the control chamber 29 communicates with the relief chamber via the relief conduit 14. In this switching position, the fuel at high pressure, furnished from the fuel inlet 24, assures that the first valve sealing face 9 of the control valve member 8 will lift from the first valve seat 10, counter to the prestressing force of the control valve spring 13. The second valve sealing face 19 of the control valve member 8 is then in contact with the second valve seat 20. In the switching position shown for the control valve, the fuel inlet 24 communicates with the high-pressure conduit 25. Fuel subjected to high pressure thus reaches the nozzle needle 5 through the high-pressure conduit 25

The spacing between the first valve sealing face 9 and the first valve seat 10 has been shown in exaggerated fashion in the accompanying drawing, to illustration the function of the control valve. When the valve ball 16 closes the end of the relief conduit 14 remote from the combustion chamber, the fuel subjected to high pressure, flowing through the fuel inlet 24 and through the inlet bore 27 into the control chamber 29, assures that the first valve sealing face 9 will come into contact with the first valve seat 10 and that the second valve sealing face 19 will lift from the second valve seat 20. In this switching position (not shown) of the control valve, the communication between the fuel inlet 24 and the high-pressure conduit 25 is interrupted. The pressure prevailing at the nozzle needle 5 and in the high-pressure conduit 25 is abated by the second relief conduit 26.

1. A common rail injector for injecting fuel in a common rail injection system of an internal combustion engine, which has an injector housing (1) with a fuel inlet (24) that communicates with a central high-pressure fuel reservoir outside the injector housing (1), and which can be made to communicate with a high-pressure conduit (25) inside the injector housing (1), from which conduit fuel subjected to high pressure is injected into the combustion chamber of the engine when a control valve member (8), movable axially back and forth in a longitudinal bore (4) of the injector (1) lifts, with a first valve sealing face (9), from a first valve seat (10) as a function of the pressure in a control chamber (29), characterized in that the control chamber (29) is formed by a substantially cylindrical recess (12), provided in the end (11) of the control valve member (8) remote from the combustion chamber, the diameter (d₂) of which recess is greater than the diameter (d₁) of the first valve seat (10), and which recess at least partly surrounds a guide peg (13) that is stationary relative to the injector housing (1).

2. The common rail injector of claim 1, characterized in that a first relief conduit (14) is embodied in the guide peg (13) and connects the control chamber (29) to a relief chamber when a blocking device (16) opens.

3. The common rail injector of claim 2, characterized in that in the end (11), toward the control chamber (29), of the control valve member (8) an inlet bore (27) with an inlet throttle (28) is provided, which discharges into the recess (12), and whose cross section is smaller than the cross section of the first relief conduit (14).

4. The common rail injector of one of the foregoing claims, characterized in that a prestressed control valve spring (31) is disposed outside the guide peg (13), between the control valve member (8) and the valve housing (1).

5. The common rail injector of one of the foregoing claims, characterized in that the control valve member (8) has a second valve sealing face (19), which cooperates with a second valve seat (20) in order to open and close a communication between the high-pressure conduit (25) and a second relief conduit (26) that communicates with the relief chamber.
